(19) United States
(12) Patent Application Publication
(10) Pub. No.: US 2004/0193492 A1
(43) Pub. Date: Sep. 30, 2004

(54) Navigation and promotion distribution system

(76) Inventor: Ted H. Applebaum, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/817,374

(22) Filed: Apr. 2, 2004

Related U.S. Application Data
(62) Division of application No. 10/289,661, filed on Nov. 7, 2002.

(51) Int. Cl. G06F 17/60; G01C 21/26; G01C 21/28; G01C 21/30; G01C 21/32; G01C 21/34; G01C 21/36

(52) U.S. Cl. 705/14; 701/200

(57) ABSTRACT

A navigation and promotion system has a navigation module receptive of information relating to a current location of a user, a target destination, and location-dependent navigational options, wherein the navigation module is adapted to generate a navigational instruction based on the navigational options, the current location, and the target destination. A promotion module is receptive of information relating to user needs, promotional offers, and the target destination. The promotion module is adapted to select a promotional offer based on an inference of user interest, wherein the inference of user interest is based on the target destination. An output is adapted to communicate the navigational instruction and the selected promotional offer to the user.

### FIELD OF THE INVENTION

The present invention generally relates to vehicle navigation methods and systems, and particularly relates to promotion distribution methods and systems having user interest inference capability.

### BACKGROUND OF THE INVENTION

Vehicle navigation systems using Global Positioning Systems (GPS) technology are becoming quite common in automobiles. Vehicle operators can generally communicate with such systems using speech input, and receive navigational instructions by speech output, so that the vehicle operators can operate the system in a hands free and eye free fashion while concurrently operating the vehicle. In addition to providing an address or intersection to identify a target destination, users can generally express a desire for a particular type of destination, such as an area populated by restaurants, or a particular place of business, such as a particular restaurant chain, and receive navigational instructions for reaching the target destination. A dialogue manager is also typically provided to assist in carrying on a dialogue with a user to narrow a field of search, present various options, or suggest an alternative search. An opportunity, therefore, arises for promoting a particular vendor to a user when the user expresses a present need for a particular good, service, and/or associated category, such as food or restaurants. This opportunity has potential value for vendors of goods and services. Of similar potential value is a generally unrecognized opportunity to promote particular vendors based on an inference of user interest stemming from more than a present expression of a need by the user for a particular good, service, and/or associated category. This value increases with increased market penetration of the navigation system and increased knowledge relating to user needs.

Market penetration of the vehicle navigation system presents certain challenges, because the cost of an automobile can be greatly increased by inclusion of a navigation system due to the associated costs of the system. What is needed is a way to decrease the cost of the system for consumers to increase market penetration. What is also needed is a way to infer user interest based on more than a present expression of a need by the user for a particular good, service, and/or associated category. The present invention fulfills both of the aforementioned needs.

### SUMMARY OF THE INVENTION

According to the present invention, a navigation and promotion system has a navigation module receptive of information relating to a current location of a user, a target destination, and location-dependent navigational options, wherein the navigation module is adapted to generate a navigational instruction based on the navigational options, the current location, and the target destination. A promotion module is receptive of information relating to user needs, promotional offers, and the target destination. The promotion module is adapted to select a promotional offer based on an inference of user interest, wherein the inference of user interest is based on the target destination. An output is adapted to communicate the navigational instruction and the selected promotional offer to the user.

The vehicle navigation system according to the present invention is advantageous over previous vehicle navigation systems in that it has the ability to anticipate user needs based on knowledge relating to user personal information, user consumption preferences, a user consumption history, user vehicle operation preferences, a user vehicle operation history, and/or present or inferred future user environment. Thus, the system provides a service that is valuable to both users of the system and vendors who benefit from the distribution of promotional offers. Users are also motivated to provide information relating to user needs to increase functionality of the system and to receive discounts or other benefits associated with promotional offers, which can be printed and/or distributed to a user's Personal Digital Assistant (PDA). Monetary consideration provided by vendors and by sale of information relating to user needs can further be used to subsidize the cost of the vehicle navigation system, thus increasing market penetration and value of the system to vendors. Resulting increased vendor participation further increases value of the system to users. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram depicting a vehicle navigation system according to the present invention;

FIG. 2 is a flow chart depicting a method of inferring user interest and distributing promotions according to the present invention;

FIG. 3 is a block diagram depicting various information sources according to the present invention; and

FIG. 4 is a flow chart depicting a method of doing business according to the present invention.

### DETAILED DESCRIPTION OF THE PREFERRED EMBODIMENTS

The navigation and promotion system according to the present invention is described herein with reference to an automobile navigation system implementing GPS technology as an information source. It should be readily understood, however, that the vehicle navigation system of the present invention may be applied in various travel related settings implementing various types of information sources. The following description of the preferred embodiment is merely exemplary in nature and is in no way intended to limit the invention, its application, or uses.

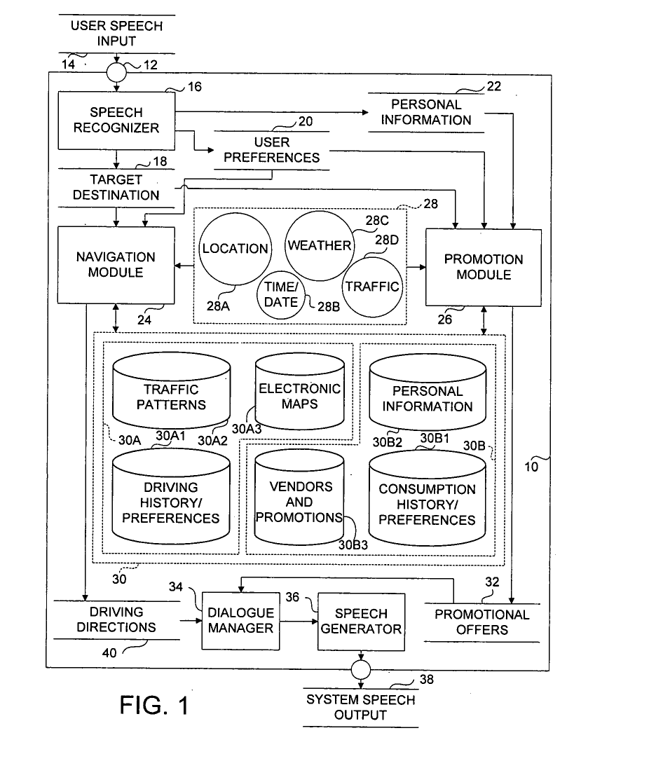

The navigation and promotion system 10 according to the present invention is illustrated in FIG. 1, and possesses many of the features exhibited by existing navigation systems with the addition of several new features. In particular, a voice input device 12, such as a microphone, is receptive of user speech input 14. Further, a speech recognizer 16 processes the user speech input 14 to extract a target destination 18, user preferences 20, and/or user personal information 22. The target destination 20, which can be a particular location and/or a particular good, service, or associated category, is communicated to navigation module 24 and to promotion module 26. The user preferences 20, which can relate to driving preferences and/or consumption preferences, are similarly communicated to navigation module 24 and to promotion module 26. The personal information 22, which can relate to the user identity, associated family, characteristics of the user and/or associated family, and/or significant occasions (birthdays, anniversaries, etc.), is communicated to promotion module 26.

The navigation and promotion system 10 makes use of various types of information sources to supplement and constrain the target destination 18, user preferences 20, and/or personal information 22 extracted from the present user speech input 14. For example, regional characteristics 28, such as location 28A, time and day 28B, weather 28C, and/or traffic 28D are communicated to navigation module 24 and promotion module 26. Further, stored information 30, such as navigational information 30A and promotional information 30B are communicated to navigation module 24 and promotion module 26. The navigational information 30A includes driving history and/or preferences 30A1, traffic patterns 30A2, and electronic maps 30A3 containing location and destination dependent navigational instructions. The promotional information 30B includes consumption history and/or preferences 30B1, personal information 30B2, and/or vendor and promotion information 30B3 containing location and/or destination dependent promotional offers. Each of the driving history and/or preferences 30A1, traffic patterns 30A2, consumption history and/or preferences 30B1, and/or personal information 30B2 can be recorded during the course of vehicle operation by navigation module 24 and/or promotion module 26, and/or provided and/or supplemented externally on a periodic basis. Similarly, the electronic maps 30A3 and/or vendor and promotion information 30B3 can be provided externally on a periodic basis, but can also be amended during vehicle operation as needed by navigation module 24 and/or promotion module 26.

In accordance with the present invention, promotion module 26 is adapted to select a promotional offer 32 based on an inference of user interest stemming from an anticipation of user needs, such as a need to arrive at a target destination. For example, promotional module 26, with knowledge that it is lunchtime, that the user is headed across town to a meeting starting in one hour, that traffic is not currently or typically slow along a prescribed route from the current location to the target destination, and knowing that the user likes Chinese food and is not on a restricted diet, can select a promotional offer 32 good for a discount at a particular Chinese restaurant along the prescribed route. In particular, promotional module 26 can perform this function absent a present speech input 14 expressing a need for food. As another example, promotional module 26, with knowledge that the user has three children, that one of the children has a birthday on an approaching weekend, that the three children can swim, that the weather forecast is for high temperatures and sunny skies, and that a particular water park is going to be open on the weekend in question, can select a promotional offer 32 good for a discount on admission at the water park on the child's birthday. In particular, promotional module can perform this function based on information recorded during previous user interaction with the system 10, based on information extracted from speech uttered in the vehicle for reasons other than interaction with the system 10, and/or based on information provided during an enrollment process. Additionally, promotion module 26 can perform this function based in whole or in part on a user need expressed by a present speech input 14.

Selected promotional offers 32 are communicated to a dialogue manager 34, which formulates a prompt to express the promotional offer 32 to the user of the system 10. Speech generator 36 generates speech based on formulated prompts, such that the generated speech communicates the formulated prompts to the user as system speech output 38. The user can reject a selected promotional offer 32 with a user speech input 14, or accept one or more of several promotional offers 32 in the same way. A rejection may constitute a new user preference 20 or personal information 22, especially if the rejection contains a reason for the rejection. An acceptance also constitutes new information confirming and or supplementing user preferences and/or personal information 22 and recordable as consumption history and/or preferences 30B1, and/or personal information 30B2. Also, an acceptance may constitute a new target destination 18.

Dialogue manager can be useful for extracting information needed by promotion module 26 to determine whether to select a promotional offer 32. For example, if weather information is not available, and/or if it is not known whether each of the three children can swim, then promotion module 26 may tentatively select a promotional offer 32 for the water park and communicate the tentatively selected promotional offer 32 to the dialogue manager 34 with certain conditional fields flagged. As a result of the weather conditions and swimming ability conditional fields being flagged, dialogue manager 34 can formulate prompts designed to extract information relating to a weather forecast and/or swimming ability, and information contained in an extracted response can be recorded for future reference. Alternatively or in addition, a prompt can be formulated to communicate the selected promotional offer 32 as subject to the flagged conditions. As another example, a promotional offer 32 for a hotel stay may be conditioned on room availability, such that dialogue manager 32 may formulate a prompt to communicate the conditions, and/or, with the user's permission, initiate a cell phone call to the hotel desk clerk to allow the user to determine room availability, negotiate a personalized offer, and/or make a reservation.

In contrast with the novel promotion module 26, navigation module 24 operates in a fashion generally well known by receiving a target destination and generating driving directions 40 based on regional characteristics 28 and navigational information 30A. The driving directions 40 are similarly communicated to dialogue manager 34, which formulates a prompt for communicating the driving direction. Again, speech generator 36 generates speech that communicates formulated prompts to the user as system speech output 38.

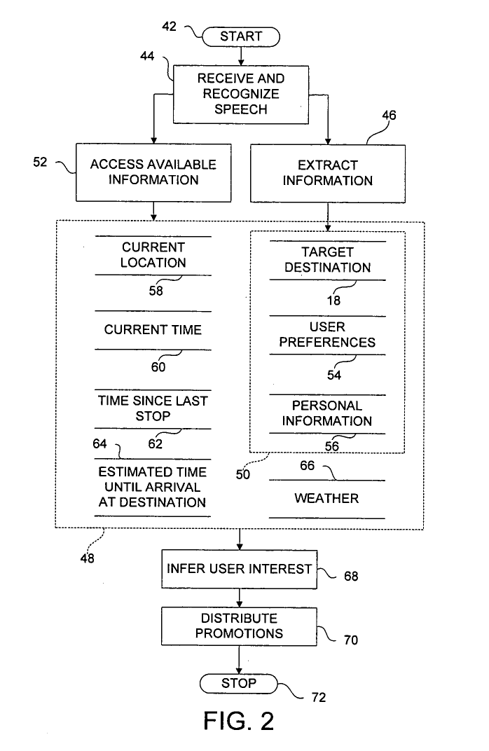

The method of inferring user interest and distributing promotions accordingly for use with a vehicle navigation system according to the present invention is illustrated in FIG. 2. Beginning at 42, user speech is received and recognized at step 44, and information is extracted from the speech at step 46. Available information 48, including extracted information 50, is accessed in step 54. Examples of extracted information include target destination 18, stored, extracted and/or recently extracted user preferences 54, and stored, extracted and/or recently extracted personal information 56. Other types of available information include current location 58, current time 60, a time since a last stop (based on recorded driving history) 62, an estimated time until arrival at the target destination 64 (based on recorded driving history, current location, known route, time, date, and weather, and/or traffic conditions or patterns), and sensed or forecasted weather 66. Additional types of available information can include vehicle characteristics, including fault detection, service history, and/or gas level. It should be readily understood that there exist too many types of information that are useful for inferring user interest than can be listed here, but that can nevertheless be available information 48.

The available information is used at step 68 to infer user interest by anticipating user needs based on the available information 48. For example, the system can infer a user interest in stopping for gas by anticipating a need for gasoline based on a lengthy time since a last stop 62. Further, the system can infer a user interest in staying at a hotel based on a current time 60 and an estimated time until arrival at the target destination 48. Automobile service history and/or fault detection can also be used to anticipate a need for an oil change or other service work. With the interest of the user inferred at step 68, promotions are distributed based on the inferred user interest at step 70, and the method ends at 72.

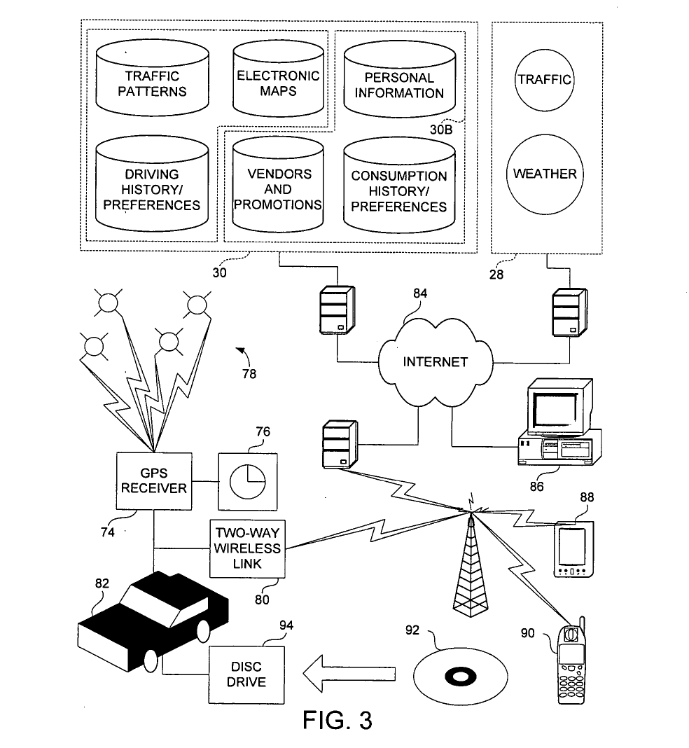

Operation of system 10 is dependent to some degree on availability of information sources, and many types of potentially available information sources are illustrated in FIG. 3. As a default, the vehicle navigation system can at least communicate a prompt to a user to determine whether a condition associated with an offer is favorable for selection of the offer. Preferably, however, the vehicle navigation system implements a GPS receiver 74 to sense location and time 76 based on communication with GPS satellites 78.

In one embodiment, a two-way wireless link 80 connects the vehicle 82 to a communications system that includes the Internet 84, so that stored information 30 and/or regional characteristics 28 can be maintained and/or acquired online in addition to being stored in vehicle 82. One advantage of this embodiment is that the user's consumer activity relating to peripheral web-enabled devices, such as the user's Personal Computer (PC) 86, PDA 88, and/or cell phone 90, can be monitored and/or used to maintain and/or update promotion information 30B that is maintained online. Another advantage of this embodiment is that the user can engage in ecommerce using the navigation system, for example, by checking hotel availability and making reservations online.

In another embodiment, stored information is provided on disc 92, such as CD or DVD, in much the same way that electronic maps are presently provided to users of automobile navigation systems via a disc drive 94. Information relating to vendors and promotions can thus be periodically provided in the form of an electronic activity guide. Such a guide can take the form of an electronic Yellow Pages that provides information relating to many competing vendors, or be more limited in its scope by exclusively providing information on particular vendors of non-competing services. Also, user preferences and/or personal information can be periodically provided based, for example, on an enrollment procedure that requires the user to fill out forms and/or surveys online, by mail, and/or by phone. Collected information can be stored on disc and sent to the user or made available online for the user to burn on disc. A similar procedure can also be implemented in the vehicle 82 using a dialogue-based interview conducted by the system.

In yet another embodiment, promotional offers are actively pushed to the system by radio (smart highway) messages. If the messages correspond to sequences of text, the vehicle's onboard computer can perform intelligent filtering on all of the text bursts that arrive based on inferred needs and/or directly expressed user preferences. Thus, if the system has knowledge that it is lunchtime and/or if the user communicates to a passenger a need for food, the system can filter out other messages in favor of offers relating to nearby restaurants. A known preference for Chinese food can be used to further filter out other types of food if Chinese food is available, unless the user rejects the offer of Chinese food. If an address and/or intersection is included in the message, then the system can further offer driving directions, and/or can look up the establishment by name in an electronic index to ascertain the target destination.

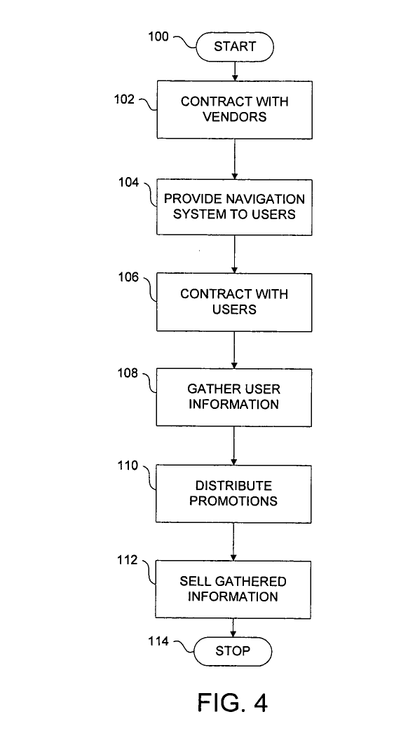

A method of doing business according to the present invention is illustrated in FIG. 4. Beginning at 100, vendors are solicited to subscribe to participate in step 102 by providing both monetary consideration and promotional offers that provide a considerable benefit to users. For example, vendors may be required to pay a fee to have their business listed by the system, and fees can be scaled based on preferential treatment to be given to some vendors over others. In particular, a more detailed advertisement, perhaps containing a coupon, may require more monetary consideration than a simple listing. Offers by these vendors may also be selected and/or communicated to users first or in a preferential manner compared to offers by vendors that are simply listed. Also, vendors may be required to participate in conferring a general benefit on users of the system, such as by giving a fixed percentage discount, and/or by donating a share of proceeds to a user-selected charity and/or scholarship fund. The monetary consideration thus gained can be used to subsidize the cost of providing the system to users in step 104. Provision of the system is further based on contracting with users of the system at step 106 for rights to information gathered in step 108 by an enrollment procedure and/or during operation of the system. The gathered information is used to distribute promotions at step 110, but can also be sold at step 112 for profit and/or additional subsidization for providing the system to users at step 104. Subsidization of the system has a synergistic effect in that it increases market penetration (value to vendors), which results in greater vendor participation (value to users), which feeds back into increased market penetration. The method ends at 114.

It should be readily understood that the navigation and promotion system according to the present invention as described herein with reference to an automobile navigation system is merely an exemplary embodiment of the present invention. Thus, the navigation and promotion system of the present invention may be applied to various travel settings and implement various types of information sources. Moreover, the description of the invention is merely exemplary in nature and, thus, variations that do not depart from the gist of the invention are intended to be within the scope of the invention.

1. A navigation and promotion distribution system, comprising:
a navigation module receptive of information relating to a current location of a user, a target destination, and location-dependent navigational information, wherein said navigation module is adapted to generate a navigational instruction based on the navigational information, the current location, and the target destination;
a promotion module receptive of information relating promotional offers, and the target destination, wherein said promotion module is adapted to select a promotional offer based on an inference of user interest, wherein the inference of user interest is based on the target destination; and
an output adapted to communicate the navigational instruction and the selected promotional offer to the user.

2. The system of claim 1, wherein said promotion module is receptive of information relating to a current time, and the inference of user interest is based on the current time.

3. The system of claim 1, wherein said promotion module is receptive of information relating to traffic characteristics in a region relating to at least one of the current location and the target destination, and the inference of user interest is based on the traffic characteristics.

4. The system of claim 1, wherein said promotion module is receptive of information relating to weather characteristics in a region relating to at least one of the current location and the target destination, and the inference of user interest is based on the weather characteristics.

5. The system of claim 1, wherein said promotion module is receptive of information relating to the current location, and the inference of user interest is based on the current location.

6. The system of claim 5, wherein said promotion module is receptive of information relating to at least one available route between a current location and a target destination, and the inference of user interest is based on the available route.

7. The system of claim 1, wherein said promotion module is receptive of information relating to an estimated time until arrival at the target destination, and the inference of user interest is based on the estimated time until arrival at the target destination.

8. The system of claim 1, wherein said promotion module is receptive of information relating to a time since a last stop, and the inference of user interest is based on the time since the last stop.

9. The system of claim 1, wherein the promotion system is receptive of information relating to user personal information and user preferences, and said promotional system is adapted to determine user needs based on the user personal information and the user preferences, and to infer user interest based on the user needs.

10. The system of claim 9, wherein the user personal information and user preferences are at least partially based on at least one of a user driving history and a user consumption history.

11. The system of claim 1 further comprising:
a speech recognizer adapted to recognize a user speech input, thereby extracting at least one of the target destination and user needs;
a dialogue manager adapted to formulate prompts designed to extract information relating to user needs; and
a speech generator receptive of the generated navigational instructions, selected promotional offers, and formulated prompts, and adapted to generate speech useful for communicating the generated navigational instructions, selected promotional offers, and formulated prompts to the user.

12. A method of distributing a promotional offer, comprising:
receiving information relating to a target destination of the user;
receiving information relating to promotional offers;
making an inference of user interest based on the target destination;
selecting a promotional offer based on the inference of user interest; and
communicating the selected promotional offer to the user.

13. The method of claim 12, comprising:
receiving information relating to a current location of the user;
receiving information relating to location-dependent navigational options;
generating a navigational instruction based on the navigational options, the current location, and the target destination; and
communicating the generated navigational instruction to the user.

14. The method of claim 12, further comprising receiving information relating to a current time, wherein said making an inference of user interest is further based on the current time.

15. The method of claim 12, further comprising receiving information relating to traffic characteristics, wherein said making an inference of user interest is further based on the traffic characteristics.

16. The method of claim 12, further comprising receiving information relating to weather characteristics in a region relating to at least one of the current location and the target destination, wherein said making an inference of user interest is further based on the weather characteristics.

17. The method of claim 12, further comprising receiving information relating to an estimated time until arrival at the target destination, wherein said making an inference of user interest is further based on the estimated time until arrival at the target destination.

18. The method of claim 12, further comprising receiving information relating to a time since a last stop, wherein said making an inference of user interest is further based on the time since the last stop.

19. The method of claim 12, comprising receiving information relating to user needs, including:
(a) receiving information relating to user personal information and user preferences; and
(b) determining the user needs based on the user personal information and the user preferences.

20. The method of claim 19, wherein the user personal information and user preferences are at least partially based on at least one of a user driving history and a user consumption history.

21. The method of claim 12 further comprising:
receiving a user speech input;
performing speech recognition on the user speech input, thereby extracting information relating to user needs;
formulating a prompt designed to extract information relating to user needs;
generating speech useful for communicating the generated navigational instructions, selected promotional offers, and formulated prompts to the user; and
communicating the generated speech to the user.

22. The method of claim 12 comprising receiving information relating to at least one available route between the target destination and a current location, wherein said making an inference of user interest based on the target destination includes making an inference of user interest based on the available route.

23. The method of claim 12 comprising computing information relating to at least one available route between the target destination and a current location, wherein said making an inference of user interest based on the target destination includes making an inference of user interest based on the available route.

24. A method for providing navigational instructions to a person traveling in a vehicle, the vehicle having a navigation system therein, comprising:
inferring an interest of a person traveling in a vehicle;
identifying a potential vehicle target destination relating to the inferred interest of the person; and
providing navigational instructions that correspond to the potential vehicle target destination.

25. The method of claim 24 further comprising:
determining information pertaining to the operation of the vehicle; and
inferring the interest of the person based in part on the information pertaining to the operation of the vehicle.

26. The method of claim 25, wherein said determining information pertaining to the operation of the vehicle includes receiving information relating to previous vehicle operation.

27. The method of claim 26, wherein said receiving information relating to previous vehicle operation includes receiving information relating to a time since a last stop.

28. The method of claim 25, wherein said determining information pertaining to the operation of the vehicle includes receiving information relating to present vehicle condition.

29. The method of claim 28, wherein said receiving information relating to present vehicle condition includes receiving information relating to automated fault detection associated with the vehicle.

30. The method of claim 25, wherein said determining information pertaining to the operation of the vehicle includes receiving information relating to future vehicle operation.

31. The method of claim 28, wherein said receiving information relating to future vehicle operation includes receiving information relating to an estimated time until arrival at a target destination.

32. A method for distributing promotional information to a person located in a vehicle, the vehicle having a vehicle navigation system therein, comprising:
determining information pertaining to operation of the vehicle;
inferring an interest of the person based in part on the information pertaining to the operation of the vehicle; and
communicating promotional information relating to the inferred interest of the person located in the vehicle.

33. The method of claim 32, wherein said determining information pertaining to the operation of the vehicle includes receiving information relating to previous vehicle operation.

34. The method of claim 33, wherein said receiving information relating to previous vehicle operation includes receiving information relating to a time since a last stop.

35. The method of claim 32, wherein said determining information pertaining to the operation of the vehicle includes receiving information relating to present vehicle condition.

36. The method of claim 35, wherein said receiving information relating to present vehicle condition includes receiving information relating to automated fault detection associated with the vehicle.

37. The method of claim 32, wherein said determining information pertaining to the operation of the vehicle includes receiving information relating to future vehicle operation.

38. The method of claim 37, wherein said receiving information relating to future vehicle operation includes receiving information relating to a target destination.

39. The method of claim 38, wherein said receiving information relating to a target destination includes receiving information relating to at least one available route between a current location and a target destination.

40. The method of claim 37, wherein said receiving information relating to future vehicle operation includes receiving information relating to an estimated time until arrival at a target destination.

41. The method of claim 32, further comprising:
determining a target vehicle destination for the vehicle; and
inferring an interest of the person based in part on the target vehicle destination.

42. A method of marketing a vehicle navigation system, comprising:
contracting with vendors to distribute promotional offers to users of the vehicle navigation system in exchange for monetary consideration;
providing the vehicle navigation system to users, wherein the navigation system is adapted to make an inference of user interest based on information relating to user needs and at least one of a current location and a target destination, and adapted to distribute promotional offers based on the inferred user interest;
gathering information from the user that relates to user needs; and
distributing promotional offers to the users via the vehicle navigation system.

43. The method of claim 42, comprising subsidizing a cost of the vehicle navigation system with the monetary consideration.

44. The method of claim 42, comprising:
contracting with the users to provide the vehicle navigation system to the users in exchange for rights to gather and sell information relating to user needs;
selling information relating to user needs to interested parties in exchange for monetary consideration.

45. The method of claim 44, comprising subsidizing a cost of the vehicle navigation system with the monetary consideration.

46. The method of claim 42, wherein said gathering information from the user that relates to user needs includes recognizing user speech uttered in the vehicle that contains information relating to user needs, thereby extracting information relating to user needs.

47. The method of claim 46, wherein the user speech uttered in the vehicle includes speech uttered for reasons other than interaction with the vehicle navigation system.
